(19) United States
(12) Patent Application Publication
(10) Pub. No.: US 2007/0159042 A1
(43) Pub. Date: Jul. 12, 2007

(54) Lighting device with mercury absorbing/adsorbing and/or blocking agent

(76) Inventors: Klaus Klinkenberg, Aachen (DE); Holger Monch, Vaals (NL); Ulrich Niemann, Aachen (DE); Garrett Forde, Twello (NL); Andreas Martinus Theodorus Paulus Van Der Putten, Geldrop (NL); Jan Alfons Julia Stoffels, Turnhout (BE); Patrick Cyriel Van De Voorde, Turnhout (BE); Marc Francois Rosalla Janssen, Kasterlee (BE); Engelbertus Cornelius Petrus Maria Vossen, Eindhoven (NL); Pieter Johannes Stobbelaar, Eindhoven (NL); Theodorus Leonardus Gerardus Maria Thijssen, Meijel (NL)

Correspondence Address: PHILIPS INTELLECTUAL PROPERTY & STANDARDS, P.O. BOX 3001, BRIARCLIFF MANOR, NY, 10510, US

(21) Appl. No.: 10/572,926

(22) PCT Filed: Sep. 22, 2004
(86) PCT No.: PCT/IB04/51823

§ 371 Date: Jan. 9, 2007

(30) Foreign Application Priority Data
Sep. 26, 2003 (EP) 03103576.9
Apr. 26, 2004 (EP) 04101730.2

(51) Int. Cl. H01K 1/30; H01J 61/40; H01K 1/58; H01J 5/16

(52) U.S. Cl. 313/17; 313/110

(57) ABSTRACT

The invention relates to a lighting device comprising a lamp comprising a burner with an ionizable filling and an amount of mercury contained herein, having at least one mercury absorbing/adsorbing and/or blocking means located outside the burner for the fixation of mercury in case of an explosion of the burner.

The present invention relates to a lighting device with a lamp containing mercury, e.g. an UHP (Ultrahigh-pressure) lamp.

In present art UHP lamps, it is necessary to use mercury to achieve proper operation of the lamp. Although the amounts used are merely in the range of 10-25 mgs per lamp, there has been a growing concern that in case of an explosion of the lamp, the outside of the lamp might be exposed and contaminated by the mercury. Such explosions can up to date never be avoided, even with the highest standard lamps. The main two reasons for such lamp explosions are:
1.) The explosion takes place when the lifetime of the lamp has nearly ended due blow up because of recrystallisation of the quartz bulb. By monitoring the lamp voltage, these blow-ups can be avoided, if the lamp is turned down, when certain criteria are met. A control device is e.g. disclosed in the EP 1 076 478.
2.) The explosion takes place due to tension in the quartz. This can up to date not be detected and may lead to explosion during any time the bulb is operated.

Since the risk of an explosion of the lamp cannot be eliminated, it must be taken care that the mercury contained inside the lamp is not exposed to the outside, if such an explosion happens. Therefore several attempts have been proposed to deal with this problem:

The EP 1 003 202 discloses a discharge lamp, which employs a higher-pressure and higher-wattage lamp body and is capable of effectively preventing the scattering of broken pieces of the lamp body at explosion of the lamp body. The discharge lamp comprises a lamp body, a reflector having the lamp body, and a front glass fitted on a front portion of the reflector, wherein the reflector has vent holes in which mesh sheets or perforated plates are fitted. Even if the lamp body explodes, broken pieces of the lamp body do not pass through the holes thereby to be prevented from scattering outside.

Similar devices are disclosed in the EP 1 164 328 and JP 2002216531.

The above-described devices still bear the following disadvantages:

The EP 1 003 202 EP 1 164 328 and JP 2002216531 show devices, in which the mercury is hindered to advance upon the outside of the lamp by introducing a pure mechanical object e.g. a glass means, which serves as a barrier. The mercury itself stays unaffected. If a leakage occurs in the glass means, it is free to advance to the outside of the lamp.

It is therefore an object of the present invention to provide a device which is capable of effectively hindering the mercury contained in the lamp to advance to the outside of the lamp in case an explosion happens.

This object is achieved by a lighting device as disclosed in Claim 1 of the application. Accordingly, a lighting device is provided, comprising a lamp (1) comprising a burner (10) with an ionizable filling and an amount of mercury contained therein, having at least one mercury absorbing/adsorbing and/or blocking means (40;70) located outside the burner (10) for the fixation of mercury in case of an explosion of the burner (10).

It should be noted that the term “lamp” in the sense of the present invention may be understood as a device, which comprises a burner but not being a burner. A lamp in the sense of the present invention may be a device, which comprises e.g. a burner, a reflector and a front glass.

The term “fixation” in the sense of the present invention means in particular that the mercury absorbing/adsorbing and/or blocking means is capable of hindering the mercury contained in the burner from leaving either the lamp and/or the lighting device itself. This may be done in a various ways:
The mercury absorbing/adsorbing and/or blocking means may comprise a filter, which blocks particles; and/or
The mercury absorbing/adsorbing and/or blocking means may absorb mercury physically or chemically and/or
The mercury absorbing/adsorbing and/or blocking means may contain compounds which react with mercury to form harmless mercury compounds.

The mercury absorbing/adsorbing and/or blocking means is capable of fixing ≧20%, preferably at least ≧30%, more preferably at least ≧50%, even more preferably ≧60%, yet more preferably ≧80% and most preferably at least ≧90% and ≦100% of the mercury contained in the burner after an explosion took place. By this mercury absorbing/adsorbing and/or blocking means the mercury is fixed and bonded to a known region and/or component located inside or within the vicinity of the lighting device. The mercury is furthermore unable to react with further component which may be present inside the lamp. Due to the fixation of the mercury, the lamp may be handled safely although an explosion took place.

Preferably, a mercury absorbing/adsorbing and/or blocking means to be used within the embodiment of the present invention will be able to absorb the mercury contained in the lamp, which is in the range of 20-25 mgs, in ≦2 seconds, more preferably ≦1 second, yet more preferably ≦0.5 seconds and most preferred between ≧0 and ≦0.05 seconds.

The mercury absorbing/adsorbing and/or blocking means may be located anywhere inside or in the vicinity of the lighting device. However, for some applications, certain locations of the mercury absorbing/adsorbing and/or blocking means may be preferred embodiments of the present invention.

According to one preferred embodiment of the present invention, the mercury absorbing/adsorbing and/or blocking means is located in such a way that it is inside or within the vicinity of the lamp. In this case, it is especially preferred that the lamp and the mercury absorbing/adsorbing and/or blocking means form a unit in such a way that after an explosion of the burner occurred and the lamp needs to be replaced, the unit can be removed from the lighting device, preferably as a “single piece”.

According to one preferred embodiment of the present invention, the mercury absorbing/adsorbing and/or blocking means is located in such a way that it is near or within in- and/or outlets for fluid of the lamp. In most applications it is needed that the lamp is cooled by a fluid, which is in most cases simply air. In this case, the mercury absorbing/adsorbing and/or blocking means can be located near or within in- and/or outlets for fluid of the lamp, thus ensuring a fixation of mercury that would otherwise leave the lamp via these in- and/outlets.

According to one preferred embodiment of the present invention, the mercury absorbing/adsorbing and/or blocking means is located in such a way that it is near or within in- and/or outlets for fluid of the lighting device. When the lamp needs to be cooled by a fluid, e.g. air, it may also be advantageous to locate the mercury absorbing/adsorbing and/or blocking means near the in- and/or outlets of the lighting device. In this case, the mercury absorbing/adsorbing and/or blocking means can be located near or within in- and/or outlets for fluid of the lighting device, thus ensuring a fixation of mercury that would otherwise leave the lighting device via these in- and/outlets.

It should be noted that according to the present invention, the mercury absorbing/adsorbing and/or blocking means may be used in a continuous way and/or only after an explosion took place. However, for most applications, a continuous use of the mercury absorbing/adsorbing and/or blocking means may be preferred, because then there will be no time delay between the explosion of the burner and the time it would need to install the mercury absorbing/adsorbing and/or blocking means. However, it is also possible to use the mercury absorbing/adsorbing and/or blocking means only after an explosion of the burner. In this case, it is preferred that additional detecting means for the explosion are present.

According to one preferred embodiment of the present invention, the mercury absorbing/adsorbing and/or blocking means comprises a mercury blocking means.

According to a preferred embodiment of the present invention, this mercury blocking means is capable of blocking mercury particles, preferably of a particle size of ≧1 micron, more preferably of a particle size of ≧0.5 microns, and most preferably of a particle size of ≧0.3 microns.

According to a preferred embodiment of the present invention, the mercury blocking means comprises a filter means. Preferably the filter means comprises a HEPA-Filter (High Efficiency Particulate Air) and/or is made out of a material comprising glass micro fibers.

According to a preferred embodiment of the present invention, the mercury blocking means is provided in form of a column, preferably in an essentially cylindrical shape. In this case, the column has preferably an inner diameter of ≧60 mm and ≦120 mm, preferably of ≧80 mm and ≦100 mm and a height of ≧10 mm and ≦30 mm, preferably of ≧15 mm and ≦25 mm.

According to one preferred embodiment of the present invention, the mercury absorbing/adsorbing and/or blocking means comprises a mercury absorbing/adsorbing means.

According to one preferred embodiment of the present invention, the mercury absorbing/adsorbing and/or blocking means comprises a mercury absorbing/adsorbing means and a mercury blocking means, although for some applications, either a mercury absorbing/adsorbing means or a mercury blocking means alone may be sufficient.

According to one preferred embodiment of the present invention, the at least one mercury absorbing/adsorbing and/or blocking means comprises a mercury absorbing/adsorbing means and a mercury blocking means, which are provided in such a way that mercury that will leave the burner after an explosion of the lamp will pass both the mercury absorbing/adsorbing means and the mercury blocking means before leaving the lighting device.

This mercury absorbing/adsorbing means may either absorb/adsorb the mercury physically and/or chemically or both. It should be noted, that the mercury absorbing/adsorbing means is especially useful for the fixation of mercury vapours, whereas a mercury blocking means is especially useful for mercury particles. In case that the mercury absorbing/adsorbing means comprises a compound, which binds or reacts physically and/or chemically with mercury, this compound may also be referred to as mercury absorbing/adsorbing agent.

According to one preferred embodiment of the present invention, the mercury absorbing/adsorbing and/or blocking means comprises a compound, which absorbs mercury by precipitation of Hg(I) and Hg (II) e.g. in form of their periodates and/or sulfides and/or iodides.

According to one preferred embodiment of the present invention, the mercury absorbing/adsorbing and/or blocking means comprises active carbon and/or aluminum oxide or mixtures thereof. Preferably the active carbon and/or the aluminum oxide is impregnated or provided with sulfur and/or iodine.

It should be noted, that active carbon itself is a suitable mercury absorbing/adsorbing means and/or agent; however, the removal of elemental mercury can be significantly improved by impregnation of sulfur-based or Iodine reactive constituents on the carbon that are capable of transforming the mercury into extremely stable sulfur or iodine containing compounds.

In case that active carbon is used as a mercury absorbing/adsorbing agent or as a compound within the mercury absorbing/adsorbing means, the active carbon preferably
is used in forms of grains or pellets with an average size of ≧0.1 to ≦4.0 mm and/or
has a surface area of ≧500 m²/g and ≦1500 m²/g, more preferably ≧700 m²/g and ≦1300 m²/g and most preferred of ≧800 m²/g and ≦1200 m²/g; and/or
has a packed bulk density of ≧300 kg/m³ and ≦1000 kg/m³, more preferably ≧300 kg/m³ and ≦1000 kg/m³ and most preferred of ≧500 kg/m³ and ≦700 kg/m³, and/or
has a sulfur content of ≧5 wt % and ≦20 wt %, more preferably of ≧10 wt % and ≦15 wt % and most preferred of ≧10 wt % and ≦13 wt %, and/or
has a iodine content of ≧0.5 wt % and ≦5 wt %, more preferably of ≧1 wt % and ≦3 wt % and most preferred of ≧2 wt % and ≦2.5 wt %.

According to one preferred embodiment of the present invention, the mercury absorbing/adsorbing means comprises a mercury absorbing/adsorbing agent supported by a monolithic carrier.

The monoliths is preferably chosen out of a group comprising ceramics, metal, metal oxides or mixtures thereof. Especially preferred are Pd or Pt (Pt+Rh), Preferably the monoliths are coated with catalytic species to oxidize the mercury.

The mercury absorbing/adsorbing agent is preferably chosen from a group comprising carbon, alumina, titania or a mixtures thereof, whereby the mercury absorbing/adsorbing agent may also be impregnated with or comprise sulfur and/or iodine.

Particularly preferred catalysts comprise Pd on Al2O3, Al2O3 and TiO2. Alternatively carbon coated monolithic catalysts with and without sulfur can be used to adsorb mercury vapor.

According to one preferred embodiment of the present invention, the mercury absorbing/adsorbing means may also contain zeolithes which are known to absorb mercury. Especially preferred zeolithes are those who have holes or cavities with the size of approximately 3-10 Å.

It should be noted the absorption of the mercury by the mercury absorbing/adsorbing means and agents can in all cases also take place simply by physical absorption and not via the formation of a chemical compound.

According to one preferred embodiment of the present invention, the absorption of the mercury is achieved via the formation of an amalgam and the mercury absorbing/adsorbing and/or blocking means contains at least one mercury-absorbing/adsorbing agent which is adapted to form an amalgam with mercury. It is known that a broad range of elements and alloys readily form amalgams with mercury. In a preferred embodiment of the present invention, the mercury-absorbing/adsorbing agent contains at least one of the elements out of the group consisting of In, Bi, Zn, Sn, Pb, Ag and Au or mixtures thereof. Preferred mixtures are on the other hand binary alloys of two elements, such as non-limiting examples Bi—In, Pb—Sn, Bi—Pb, Bi—Sn, In—Sn, In—Ag, In—Zn and/or Sn—Zn, or on the other hand ternary and higher alloys such as non limiting examples Bi—Pb—Sn, In—Sn—Ag, In—Sn—Zn, Bi—Pb—Zn, Bi—In—Pb, Bi—Sn—Au, Pb—Sn—Au and/or Pb—Sn—Zn. The content of either one component within the alloys may range from 0 to 100%. It is noted, that by using a mercury absorbing/adsorbing and/or blocking agent containing at least one element having a proper redox potential, also Hg(II)- and Hg(I)-compounds can be absorbed, since then the mercury is reduced to Hg(0) first.

The composition of the mercury absorbing/adsorbing means may be set according to the quantity of mercury to be absorbed, the required absorption speed, the temperature and/or other parameters.

The position of the mercury absorbing/adsorbing and/or blocking means can be anywhere inside or adjacent to the lighting device. In a preferred embodiment, the lamp comprises a reflector room defined by a reflector and a front glass and that the lamp and at least one of the mercury absorbing/adsorbing means is located adjacent to or within the reflector room. The mercury absorbing/adsorbing means is preferably located on the place within the reflector room, which is the coldest, after an explosion occurred, preferably in the vicinity, most preferably in the vicinity of the bottom part of the front glass. In this embodiment, a most effective absorption of the mercury can be achieved, since the gaseous mercury will liquefy predominantly on the coldest spot inside the reflector room.

In an alternative preferred embodiment, especially in case the lamp is cooled by an air or gas stream, the mercury absorbing/adsorbing means is placed in the vicinity of an air or gas outlet, preferably in the air or gas outlet, the air or gas being used to cool the lamp.

In case that air or other fluids are used for cooling the lamp and/or the burner of the lamp, it is preferred that the air and/or fluid has an flow of ≧30 and ≦400 l/min.

In another alternative preferred embodiment, the housing itself that surrounds the burner and/or the lamp comprises the mercury absorbing/adsorbing means. This can preferably done in that way, that a part of the housing is formed in such a way that mercury absorbing/adsorbing means in form of grains or pellets are filled in between two walls which are constructed essentially to build up perforated sheets. These two walls preferably form a cube- or cylinder-like structure around the burner and terminate laterally on the on side in a shatterproof window and on the other side in a fixation means for the lamp. By doing so, a steady flow of cooling gas to the burner can be maintained whilst guaranteeing that in case of an explosion the mercury is properly absorbed by the mercury absorbing/adsorbing means. In this embodiment it is furthermore preferred that—as described above—the housing including the mercury absorbing/adsorbing means may be removed as a single unit. This results in an easy handling and replacement of the housing, which after an explosion of the burner, also encloses the mercury of the burner. By this, all the mercury can be removed from the lighting device and a new unit may be inserted.

In a further preferred embodiment, the lamp comprises an antenna wire and at least a part of the wire comprising a mercury-absorbing/adsorbing means. Most preferably the wire is coated with a mercury-absorbing/adsorbing agent.

In another embodiment at least one of the mercury absorbing-means is formed, preferably by vacuum deposition as a thin layer on the reflector and/or the front glass. By doing so, a maximum surface of the mercury absorbing/adsorbing means can be achieved.

A mercury absorbing/adsorbing means as described in the present invention is preferably able to absorb ≧0.2 mg of mercury per minute, more preferably ≧0.5 mg of mercury per minute, more preferably ≧1 mg of mercury per minute, more preferably ≧5 mg of mercury per minute, yet more preferably ≧10 mg of mercury per minute and most more preferably ≧20 mg and ≦1000 mg of mercury per minute.

In yet another preferred embodiment, the lamp furthermore comprises ventilator means for cooling the reflector, wherein the ventilator means are turned off immediately after an explosion of the lamp.

Preferably the lamp furthermore comprises detection means which are adapted to detect an explosion of the lamp. This can e.g. be achieved by monitoring of the lamp voltage, which will break down in case of an explosion.

As mentioned above, according to one preferred embodiment of the present invention, the mercury absorbing/adsorbing and/or blocking means comprises a mercury absorbing/adsorbing means and a mercury blocking means.

According to a preferred embodiment, the mercury absorbing/adsorbing and/or blocking means is provided in form of an absorption column. The absorption column has preferably a first part, in which a mercury blocking means is located and a second part, in which a mercury absorbing/adsorbing means and/or agent is located. Preferably the absorption column is provided in an essentially cylindrical shape, whereby the inner diameter is preferably ≧1 mm and ≦50 mm, preferably of ≧20 mm and ≦40 mm. The first part, where the mercury blocking means is located, has a height of ≧5 mm and ≦200 mm, preferably of ≧50 mm and ≦100 mm, the second part, where the mercury adsorbing/absorbing means is located, has a height of ≧5 mm and ≦200 mm, preferably of ≧50 mm and ≦100 mm. The wall thickness of the first part is preferably ≧0.05 mm and ≦20 mm, more preferably ≦10 mm and most preferred ≦5 mm. The wall thickness of said second part is preferably ≧0.1 mm and ≦10 mm, more preferably ≦8 mm and most preferred ≦5 mm.

A lighting device according to the present invention is suitable for use in a variety of systems, amongst them shop lighting systems and/or home lighting systems and/or head lamp systems and/or accent lighting systems and/or spot lighting systems and/or theater lighting systems and/or consumer TV application systems and/or fiber-optics application systems and/or image projection systems.

This and other advantages of the present invention will become apparent out of the following description with reference to the accompanying figures, wherein

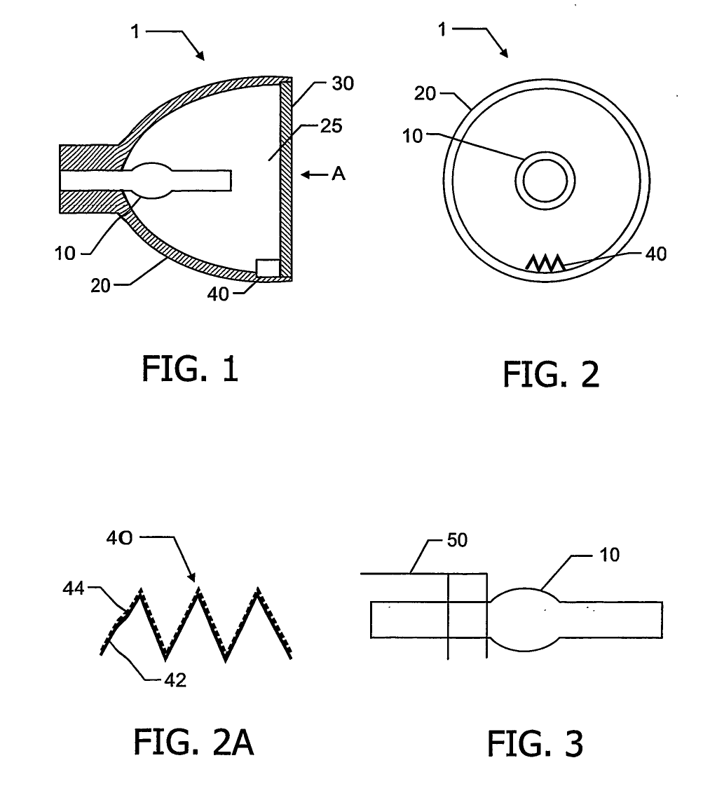

FIG. 1 shows a cross-sectional schematic view of a first embodiment of the lamp according to the present invention

FIG. 2 shows a view of the lamp of FIG. 1 as seen from arrow A

FIG. 2A shows a detailed view of the mercury absorbing/adsorbing means of FIG. 1 and 2

FIG. 3 shows in an alternative embodiment of the present invention a schematic view of a bumer having an antenna means

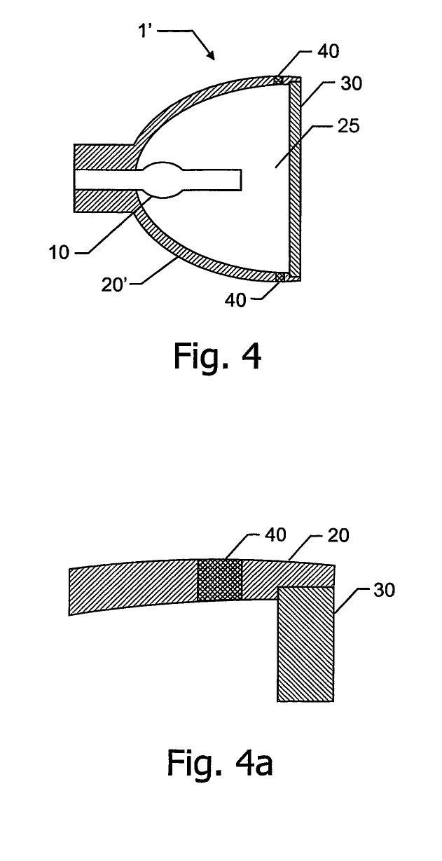

FIG. 4 shows a cross-sectional schematic view of a second embodiment of the lamp according to the present invention having a mercury absorbing/adsorbing means placed in an air or gas outlet within the reflector

FIG. 4a shows a detailed view of the mercury absorbing/adsorbing means in FIG. 4; and

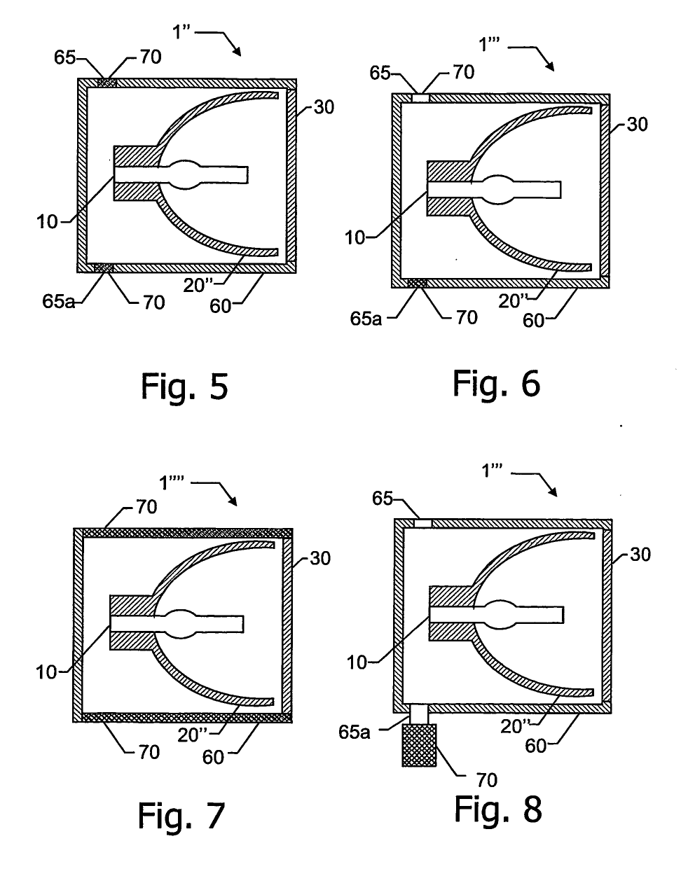

FIG. 5 shows a cross-sectional schematic view of a third embodiment of the lamp according to the present invention having a mercury absorbing/adsorbing means placed in an air or gas outlet within a housing surrounding the lamp.

FIG. 6 shows a cross sectional schematic view of a fourth embodiment of the lamp according to the present invention having a mercury absorbing/adsorbing means placed in an air or gas outlet within a housing surrounding the lamp.

FIG. 7 shows a cross sectional schematic view of a fifth embodiment of the lamp according to the present invention having a housing containing mercury absorbing/adsorbing means.

FIG. 8 shows a cross sectional schematic view of a sixth embodiment of the lamp according to the present invention having a mercury absorbing/adsorbing means in form of an absorption column

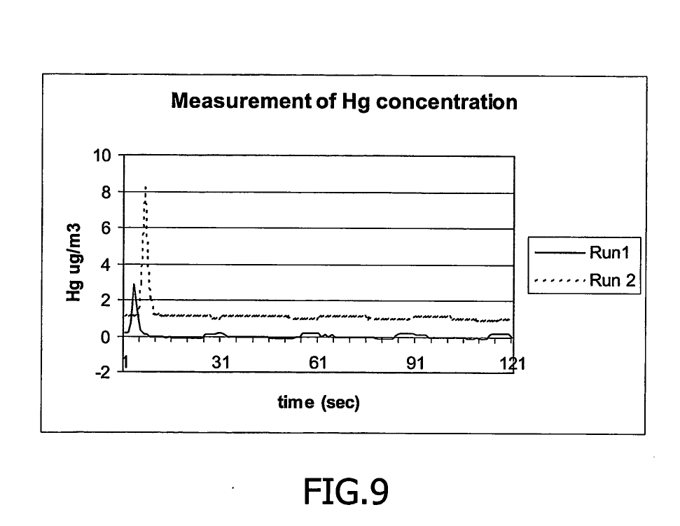

FIG. 9 is a diagram showing the amount of Mercury against time after explosion in a device according to the embodiment of FIG. 8

FIGS. 1 and 2 show a lamp 1 according to a first embodiment of the present invention, which comprises a burner 10, a reflector 20, a front glass 30, reflector 20 and front glass 30 defining a reflector room 25, and a mercury absorbing/adsorbing and/or blocking means 40 located inside the reflector room 25. Burner 10, reflector 20 and front glass 30 may be of standard technique and are not discussed in detail. However, all known types of burner 10, reflector 20 and/or front glass 30 are suitable to be used within the present invention.

The mercury absorbing/adsorbing means contain at least one mercury absorbing/adsorbing and/or blocking agent, which is capable of absorbing mercury. This is preferably be achieved by forming an amalgam with the mercury. More preferably, the mercury absorbing/adsorbing and/or blocking agent consists of one of the elements out of the group consisting of In, Bi, Zn, Sn, Pb, Ag and Au or mixtures thereof, since these elements are known to readily form amalgams with mercury. A mercury absorbing/adsorbing and/or blocking agent which has already proven itself in practice consists of indium, e.g. as a foil or wire. By using this agent, it is possible to absorb 50% of the mercury contained in the reflector room within 60 Minutes.

Due to the fact that according to the present invention the mercury is bonded and fixed, instead of merely being hindered to leave the reflector room by e.g. a glass frame, there is no need that the lamp itself needs to be air-tight, thereby leaving more room for variation in the design and technical features of the lamp.

FIG. 2A shows a detailed view of the mercury absorbing/adsorbing means 40 used in the first embodiment of the present invention. The mercury absorbing/adsorbing means 40 is in this embodiment a solid body located in the vicinity of the front glass. Preferably the mercury absorbing/adsorbing and/or blocking means is located on that region inside the reflector room, which is the coolest place after an explosion took place, since the gaseous mercury will preferably liquefy in this region and can then be absorbed in an efficient manner. In present art lamps, the coolest place is in the vicinity of the front glass, approximately in the vicinity of the bottom region thereof.

The mercury absorbing/adsorbing means 40 in the present embodiment comprises a folded metal or steel plate 42, which is coated with an mercury absorbing/adsorbing and/or blocking agent 42. By using the folded metal plate 42, a great surface for absorption of the mercury can be provided. The mercury absorbing/adsorbing plane typically amounts to several square centimeters, preferably as large as possible depending from its positioning within the reflector. The mercury absorbing/adsorbing and/or blocking agent 42 can be fixed to the substrate by a number of standard techniques comprising e.g. vapor deposition, sputtering or spraying of components.

FIG. 3 shows a schematic view of an alternative embodiment of the present invention comprising a burner 10 with an antenna wire 50. This antenna wire may be coiled around or located in the vicinity of the burner. A device containing such an antenna wire and the purpose of an antenna wire is e.g. shown in the WO 00/77826 A1. In the case, when an antenna wire 50 is used, the antenna wire 50 in an alternative embodiment of the present invention comprises at least one mercury absorbing/adsorbing means, e.g. in the way that the antenna wire 50 is coated with an mercury absorbing/adsorbing and/or blocking agent (not shown in the figs.). Due to the high surface of the antenna wire 50, an efficient absorption of the mercury can be obtained.

FIG. 4 shows a lamp 1′ according to a second embodiment of the present invention. This lamp differs to the lamp 1 shown in FIG. 1 in that that it is air- or gas-cooled via a stream of air or gas which is provided to flow around the burner 10. In this case it is standard technique that the reflector 20′ comprises an in- and outlet for the gas or air. In the case that such a lamp is used, the mercury absorbing/adsorbing means may preferably also contain mercury absorbing/adsorbing and/or blocking agents 40, who are placed in the in- and outlet of the air or gas, as can be seen in FIG. 4. In this case, the mercury absorbing/adsorbing means may comprise an array, on which the mercury absorbing/adsorbing and/or blocking agent is located on, as can best be seen in FIG. 4a. The array itself may be out of a material which merely serves as a basis for the mercury absorbing/adsorbing means which is placed on it or may be out of a mercury absorbing/adsorbing material itself. It is noted, that also mercury absorbing/adsorbing means e.g. in form of a folded strip or other suitable forms may be used.

In a further embodiment, as seen in FIG. 5, the lamp 1″ itself is surrounded by a housing 60. This housing 60 surrounds the lamp in case the reflector 20″ breaks. In order for the inside temperatures of the lamp to become not too high the housing 60 comprises preferably at least one air or gas in- and outlet 65, 65a. In this case, preferably the mercury absorbing/adsorbing means 70 may preferably also contain mercury absorbing/adsorbing and/or blocking agents, who are placed in or in the vicinity of the in- and outlets 65, 65a of the air or gas. Apart from the air or gas inlets 65, 65a the housing itself is air-tight and Hg-tight. The need for mercury absorbing/adsorbing means 70 to be placed in or in the vicinity of the in- and outlets of the housing results also from the design of the reflector 20″, which in most solutions of lamps of this design will not make contact with the front glass, so that a reflector room as described above does not exist.

In a further embodiment, as seen in FIG. 6, for the lamp 1′″ the mercury absorbing/adsorbing means 70 are placed in the outlet of the gas 65a. In case that a defined stream of air is existing, it can be sufficient, to have a mercury absorbing/adsorbing means placed only in the outlet of the housing 65a. Preferably the material of the mercury absorbing/adsorbing means 70 comprises carbon being impregnated with sulfur. This material has shown to have a high removal efficiency and absorption capacity.

The housing 60 can be made out of any suitable material, however, a heat conducting-material and especially a metal material is preferred. A preferred metal material is chosen from the group comprising aluminum, magnesium, zinc and mixtures thereof. As can be seen out of FIG. 5, the housing 60 has a square-like cross-section. However, also rectangle, round or oval housings can be used. Preferably, the housing has an approximately uniform wall thickness, which is ≧0.1 mm and ≦10 mm, more preferably ≧0.5 mm and ≦8 mm and most preferred ≧1 mm and ≦5 mm.

It should be noted, that an mercury absorbing/adsorbing and/or blocking agent to be contained in the mercury absorbing/adsorbing means 70 to be used within this embodiment of the present invention must preferably have a very short reaction time and a high absorption rate of mercury per time. This for the reason that in typical devices e.g. beamers the typical air or gas speed for cooling lamps is in the range of 2 m/s. So therefore the mercury absorbing/adsorbing and/or blocking agent will only be given a little time to absorb the mercury that is carried with the air or gas flow through the in- and outlets 65, 65a. Preferred mercury absorbing/adsorbing and/or blocking agents to be used within these mercury absorbing/adsorbing means 70 which have already proven themselves in practice include active carbon impregnated with sulfur and aluminum oxide impregnated with sulfur and mixtures thereof.

In another preferred embodiment (also not shown in the figs), the mercury absorbing means comprises a monolithic catalysts as described above. Then preferably, this monolithic catalysts also has preferably a cylinder-like structure with a diameter of ≧5 to ≦50 mm, more preferably ≧20 to ≦30 mm, most preferred 25 mm and a height of ≧1 to ≦150 mm, more preferably ≧80 to ≦120 mm, most preferred 100 mm.

FIG. 7 shows a cross sectional schematic view of a fifth embodiment of the lamp according to the present invention having a housing containing mercury absorbing/adsorbing means. In this embodiment, the housing comprises a shatterproof window 30 on the front side and a metal backside to fix the lamp. Furthermore the housing comprises two cylinders or cubes of perforated sheet which are connected by covers on both sides. In between these two cylinders or cubes, the mercury absorbing/adsorbing means 70 are located. This way a kind of “filtration cartridge” around the burner 10 is formed

Preferably the mercury absorbingladsorbing means comprise active carbon impregnated with sulfur with an average grain or pellet size of ≧0.1 to ≦4.0 mm. By doing so, an effective gas stream is allowed to flow to cool the launp, which is necessary for lamps with higher wattages such as lamps with wattages over 150 W. On the other hand, an effective absorption of mercury is achieved in case of an explosion.

FIG. 8 shows a cross sectional schematic view of a fifth embodiment of the lamp according to the present invention having a mercury absorbing/adsorbing means in form of an absorption column, preferably as described above. By doing so, a longer residence time of the mercury vapor is achieved, thus resulting in an increase of the removal efficiency.

In case the lamp is placed inside a projection system or projection device such a beamer, a further alternative embodiment of the present invention (not shown in the figs) is that at least part of or all of the mercury absorbing/adsorbing and/or blocking means and/or agents are placed in the air or gas inlet and/or outlet of the projection system or projection device. This way, the lamp can be of known design while still providing the objects of the present invention. It should be noted, that a mercury absorbing/adsorbing means with a high reaction rate and absorption rate, preferably as described above, should preferably be used within this embodiment of the present invention.

In a further alternative embodiment of the present invention (not shown in the figs.), the mercury absorbing/adsorbing means and/or the mercury absorbing/adsorbing and/or blocking agent are provided as a thin layer on a part or on the whole of the reflector and/or the front glass. This can e.g. be achieved by vacuum deposition. If the mercury absorbing/adsorbing and/or blocking agent is present inside the reflector room in this way, a maximum surface for mercury absorption is provided, thus securing that a maximum amount of mercury is absorbed per given period of time.

In a yet further alternative embodiment of the present invention (not shown in the figs.), the mercury absorbing/adsorbing means may be placed not within the reflector room, but in the vicinity of it or adjacent to it, but preferably in a region, where the mercury will leave the reflector room after an explosion of the burner occurred. By this arrangement, a standard lamp may still be used while still having an absorption of the mercury. It should be noted, that a mercury absorbing/adsorbing means with a high reaction rate and absorption rate, preferably as described above, should preferably be used within this embodiment of the present invention.

In some embodiments of the present invention, the reflector may be cooled by ventilation means such as a ventilator (not shown in the figs.). In this case it is preferred that the ventilator means are turned off in case an explosion happens to avoid any turbulences inside the reflector room. An effective turn-off of the ventilator means may be achieved, if the voltage of the burner is monitored. This can e.g. be done by the electronic lamp driver, which may preferably also control the ventilation means, especially turn the ventilation means on and off. In case of explosion, the voltage will break down. By proper detection means, a detection signal may then be sent-off, causing the ventilator means to be turned off.

FIG. 9 shows a mercury/time diagram employing a first example of a lighting device according to the present invention. This lighting device used as a mercury absorbing/adsorbing and/or blocking means an absorption column which had an essentially cylindrical shape and an inner diameter of 100 mm and a height of about 60 mm. The column contained a HEPA-Filter (Particle Filter P3, approx. 20 mm) and a AC-I Filter (approx. 35 mm, 120 g active carbon impregnated with iodine).

This absorption column was installed in a test device which comprises an explosion test chamber and two in- and outlets for fluids, after which the mercury absorbing/adsorbing and/or blocking means was provided in the in- and outlets of the explosion test chamber. Behind the mercury absorbing/adsorbing and/or blocking means an Hg-Detector was located. Inside the explosion test chamber, a 150 W lamp containing 11 mg Hg was installed.

At t=0, the burner of the lamp was exploded. After that, the amount of Hg which was measurable after passing the mercury absorbing/adsorbing and/or blocking means was measured. (Run 1). The experiment was repeated once (Run 2). As can be seen from the diagram, the detected amount of Hg lies in the range of only a few micrograms, resulting in a removal efficiency of more than 99%.

1. Lighting device comprising a lamp (1) comprising a burner (10) with an ionizable filling and an amount of mercury contained therein, having at least one mercury absorbing/adsorbing and/or blocking means (40;70) located outside the burner (10) for the fixation of mercury in case of an explosion of the burner (10).

2. Lighting device according to claim 1, comprising a mercury blocking means.

3. Lighting device according to claim 1, wherein the mercury blocking means is a filter means.

4. Lighting device according to claim 1, wherein the mercury blocking means is a filter comprising glass fibres, preferably a HEPA-filter.

5. Lighting device according to claim 1, comprising a mercury absorbing/adsorbing means.

6. Lighting device according to claim 1, wherein the mercury absorbing/adsorbing means is chosen from a group selected from active carbon, aluminum oxide, zeolithes, almalgam forming compounds, monolithic catalysts and mixtures thereof.

7. Lighting device according to claim 1, wherein the at least one mercury absorbing/adsorbing and/or blocking means is capable of fixing ≧20% of the mercury contained in the burner.

8. Lighting device according to claim 1, wherein the at least one mercury absorbing/adsorbing and/or blocking means is capable of fixing the mercury contained in the burner in ≦2 seconds, more preferably ≦1 second, yet more preferably ≦0.5 seconds and most preferred between ≧0 and ≦0.05 seconds.

9. Lighting device according to claim 1, wherein the at least one mercury absorbing/adsorbing and/or blocking means comprises a mercury absorbing/adsorbing means and a mercury blocking means, which are provided in such a way that mercury that will leave the burner after an explosion of the lamp will pass both the mercury absorbing/adsorbing means and the mercury blocking means before leaving the lighting device.

10. A system comprising a lighting device according to claim 1, the system being a
shop lighting system and/or,
home lighting system and/or,
head lamp system and/or
accent lighting system and/or,
spot lighting system and/or,
theater lighting system and/or,
consumer TV application system and/or,
fiber-optics application system, and/or
image projection system.
